(19) United States
(12) Patent Application Publication
(10) Pub. No.: US 2024/0407284 A1
(43) Pub. Date: Dec. 12, 2024

(54) DEVICES FOR REMOVING VEGETATION FROM GROUND SURFACES

(71) Applicant: Thomas Shupe, St. Louis, MO (US)

(72) Inventor: Thomas Shupe, St. Louis, MO (US)

(21) Appl. No.: 18/737,568

(22) Filed: Jun. 7, 2024

Related U.S. Application Data
(60) Provisional application No. 63/472,260, filed on Jun. 9, 2023.

(51) Int. Cl. A01D 7/06

(52) U.S. Cl. CPC A01D 7/06

(57) ABSTRACT

A device is provided for removing vegetation from ground surfaces. The device includes a body defining multiple channels, wherein each channel of the multiple channels has an inlet for receiving vegetation into the channel and a pinch point for capturing the vegetation in the channel. In connection therewith, a width dimension of each channel of the multiple channels at the inlet is greater than a width dimension of said channel at the pinch point.

### CROSS-REFERENCE TO RELATED APPLICATION

This application claims the benefit of, and priority to, U.S. Provisional Application No. 63/472,260, filed Jun. 9, 2023. The entire disclosure of the above application is incorporated herein by reference.

### FIELD

The present disclosure generally relates to devices for removing and/or collecting vegetation from ground surfaces such as yards, fields, etc.

### BACKGROUND

This section provides background information related to the present disclosure which is not necessarily prior art.

Rakes and other lawn tools have previously been developed to assist in collecting and/or removing debris from yards.

### SUMMARY

This section provides a general summary of the disclosure, and is not a comprehensive disclosure of its full scope or all of its features.

Example embodiments of the present disclosure generally relate to devices for removing vegetation from ground surfaces. In one example embodiment, such a device generally includes a body defining multiple channels, wherein each channel of the multiple channels has an inlet for receiving vegetation into the channel and a pinch point for capturing the vegetation in the channel, and wherein a width dimension of each channel of the multiple channels at the inlet is greater than a width dimension of said channel at the pinch point.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an example embodiment of a device according to the present disclosure for removing vegetation from ground surfaces;

FIG. 2 is an enlarged fragmentary perspective view of the device of FIG. 1;

FIG. 3 is a top plan view of another example embodiment of a device according to the present disclosure for removing vegetation from ground surfaces;

FIG. 4 is a side elevation view of the device of FIG. 3, illustrating a generally convex construction of the device (e.g., in which a body of the device curves generally upward toward a handle of the device, etc.);

FIG. 5 is a side elevation view of an alternative embodiment of the device of FIG. 3, illustrating a generally concave construction of the device (e.g., in which a body of the device curves generally downward toward a ground surface, etc.);

FIG. 6 is a top plan view of the device of FIG. 3 shown coupled to a head of a conventional rake;

FIG. 7 is a top plan view of another example embodiment of a device according to the present disclosure for removing vegetation from ground surfaces;

FIGS. 8-9 are perspective views of the device of FIG. 7;

FIGS. 10A-10B are fragmentary perspective views of another example embodiment of a device according to the present disclosure for removing vegetation from ground surfaces; and

FIG. 11 is a fragmentary perspective view of still another example embodiment of a device according to the present disclosure for removing vegetation from ground surfaces.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

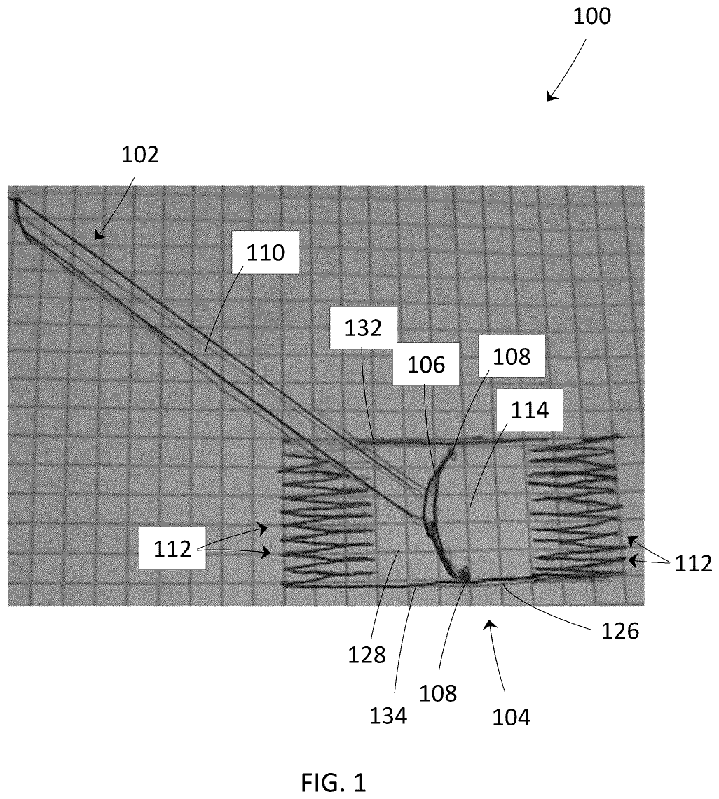

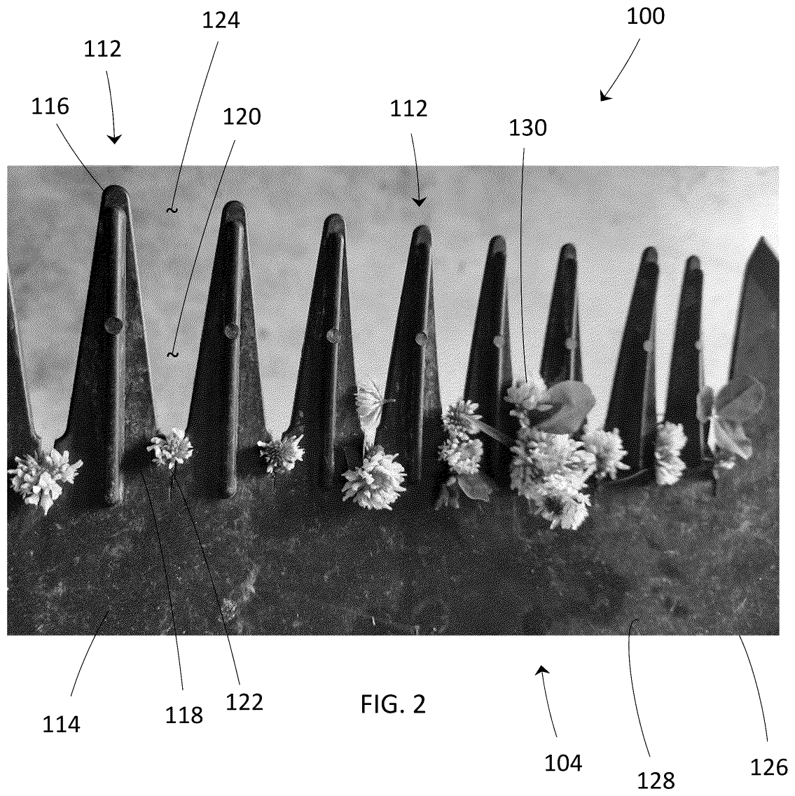

FIGS. 1 and 2 illustrate an example embodiment of a device 100 (e.g., a weed rake, a weed remover, a vegetation remover, etc.) for removing vegetation from ground surfaces, and including one or more aspects of the present disclosure. The ground surfaces may include, but are not limited to, yards, lawns, fields, etc. The vegetation to be removed may include, but is not limited to, undesired vegetation, lawn weeds, flowers from weeds (e.g., white clover flowers, dandelion flowers, etc.), etc.

As shown in FIG. 1, the illustrated device 100 generally includes a handle 102 and a body 104 (e.g., a head, etc.). The handle 102 is coupled to the body 104 and can be grasped by a user to move the device 100 across the ground surface to engage and remove vegetation from the ground surface as desired. In particular in the illustrated embodiment, the body 104 includes a mount 106 coupled thereto by fasteners 108. And, the handle 102 is then removably coupled to the body 104 by the mount 106. That said, in other example embodiments, the handle 102 may couple to the body 104 differently, for example, by threading the handle 102 directly into the body 104 (e.g., into an opening defined in the body 104, etc.), etc. Further, the handle 102 may have any suitable shape and/or length and/or circumference within the scope of the present disclosure. For example, the illustrated handle 102 includes an elongate shaft 110 configured to extend away from the body 104. In connection therewith, the handle 102 may have a suitable length and/or circumference (e.g., the shaft 110 of the handle 102, etc.) for a user to grasp and operate the device 100 (e.g., a length of about sixty inches (or more or less), and/or a rounded circumference of about three and one-half inches (or more or less), etc.).

The handle 102 of the device 100 is also coupled to the body 104 at an angle relative to the body 104 (and relative to a ground surface when the device 100 is in use, etc.). In the illustrated embodiment, the handle 102 is coupled to the body 104 at a generally (or relatively) low angle (e.g., at an angle of about fifty degrees or less relative to a plane generally including the body 104 of the device 100, at an angle of about forty-five degrees or less relative to a plane generally including the body 104 of the device 100, at an angle of about forty degrees or less relative to a plane generally including the body 104 of the device 100, etc.). This brings the handle 102 generally closer to the ground surface during use of the device 100 (e.g., when the body 104 is generally flat or flush against the ground surface, etc.), and allows (e.g., makes it possible for, makes it easier for, etc.) the user to pull the device 100 across the ground surface as well as push the device 100 forward. With that said, it should be appreciated that the handle 102 may be coupled to the body 104 at any desired angle within the scope of the present disclosure.

In the illustrated embodiment, the mount 106 is adjustable relative to the body 104 (e.g., pivotable via a hinge, etc.). As such, the handle 102 may be pivoted relative to the body 104 (via the mount 106) to thereby allow for selectively adjusting the angle of the handle 102 relative to the body 104. In doing so, the mount 106 may include one or more locks to then help retain the handle 102 (and mount 106) in the desired position or angle.

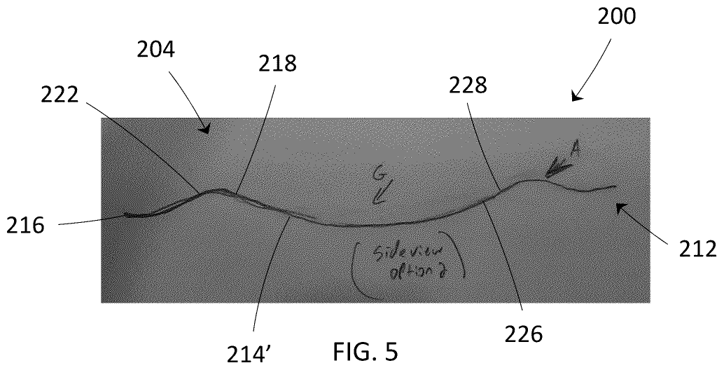

With continued reference to FIG. 1, the body 104 of the illustrated device 100 includes (e.g., is formed from, etc.) a disk or plate having a generally rectangular shape (e.g., when viewed from above or below, etc.). In connection therewith, in some example embodiments, the body 104 may have a thickness of between about 1/16 inch and about ⅛ inch (or more or less) and may be formed from a generally flexible material such as plastic, metal, etc. It should be appreciated, though, that the body 104 of the device 100 may have any suitable shape and/or size that allows for operating/using the device 100 as described herein. For example, and without limitation, the body 104 may have the generally rectangular shape with a length ranging from about one foot to about two feet (or more or less), and a width ranging from about six inches to about twelve inches (or more or less). Alternatively, the body 104 may have a generally oval or circular shape in other embodiments. In addition, in the illustrated embodiment, the body 104 is generally flat or planar. However, the body 104 may be uneven in elevation (e.g., non-planar, etc.) and/or may be arched in shape, etc. in other example embodiments (e.g., as shown in FIGS. 4 and 5, etc.).

The body 104 of the device 100 includes multiple teeth 112 extending from the body 104 and configured to engage the ground surface, and the vegetation thereon, in use of the device 100. In the illustrated embodiment, the teeth 112 are provided in rows (or sets) on opposing sides of the body 104 (e.g., a left row and a right row on respective left and right sides of the body 104 illustrated in FIG. 1, etc.). The body 104 then includes a central or middle portion 114, without teeth 112 (e.g., the central portion 114 does not include teeth and/or is free of teeth, etc.), disposed between the opposing rows of teeth 112. As such, the teeth 112 (e.g., the row or set of teeth 112, etc.) on one side of the body 104 (e.g., on one side of the central portion 114, etc.) are directed in (or face) a first direction, and the teeth 112 (e.g., the row or set of teeth 112, etc.) on the other side of the body 104 (e.g., on the other side of the central portion 114, etc.) are directed in (or face) a second direction generally opposite the first direction. The teeth 112 on both sides of the body 104 are also arranged (or disposed) in a generally common plane. In this way, as the device 100 is positioned on the ground surface with the body 104 generally parallel thereto, the teeth 112 are arranged (together) generally flush with and/or generally parallel to the ground surface.

In the illustrated embodiment, the teeth 112 are integrally formed as part of the body 104 and central portion 114 (e.g., such that the teeth 112 are monolithic with the body 104, etc.). In other embodiments, though, the teeth 112 may be coupled to, or attached to, the central portion 114 of the body 104 by suitable means (e.g., mechanical fasteners 108, welds, adhesive, etc.). For instance, in one example embodiment, the teeth 112 may be threaded into openings of the central portion 114, etc. In addition, in the illustrated embodiment, the body 104 includes twenty-two teeth 112, with eleven teeth 112 located on each side of the body 104. However, the body 104 may include more than or fewer than twenty-two teeth 112 in other examples. To this point, it should be understood that any suitable number and/or arrangement of the teeth 112 may be used in the device 100 without departing from the scope of the present disclosure.

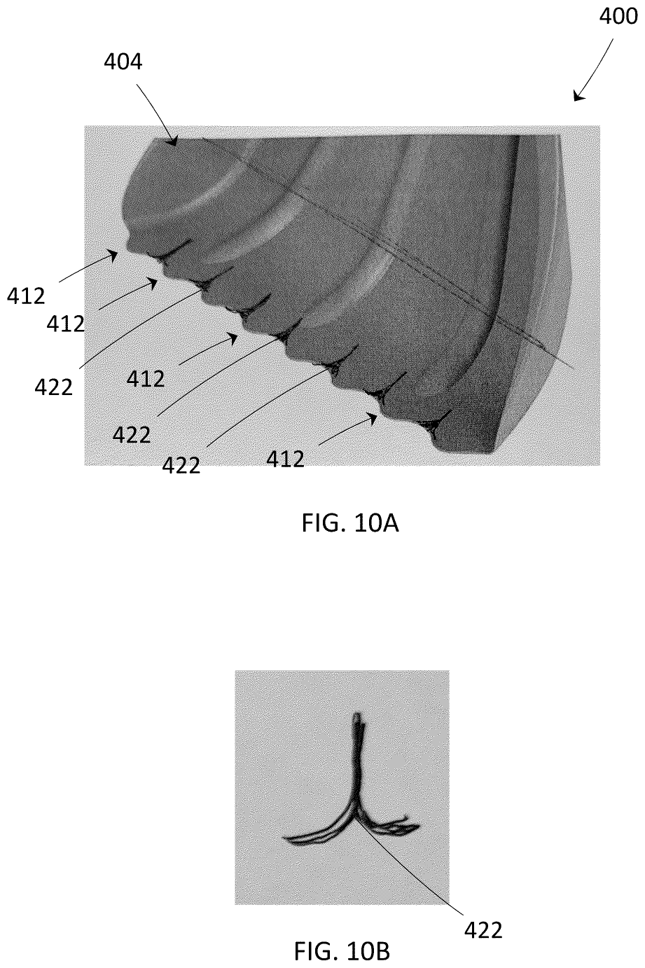

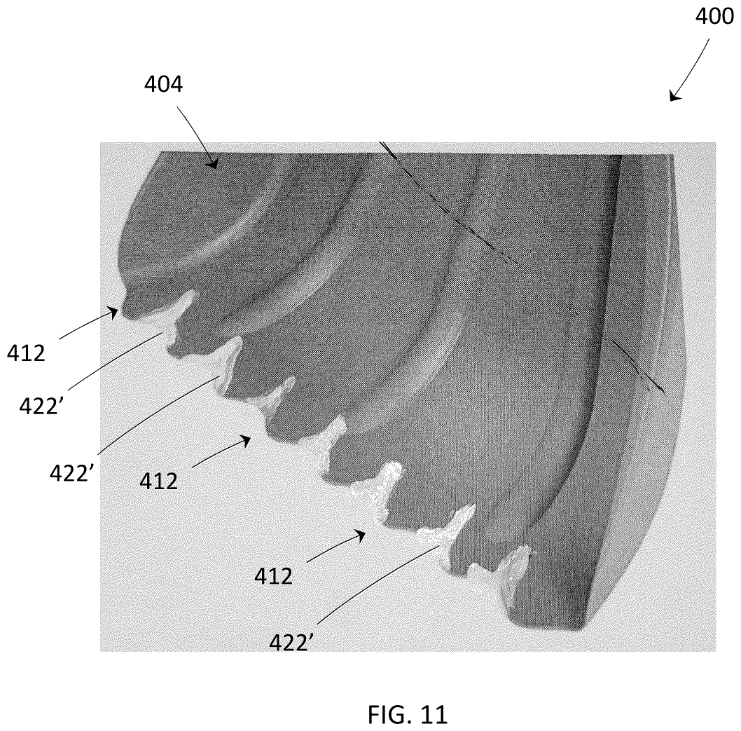

Also in the illustrated embodiment, the teeth 112 are generally linear in shape (e.g., not curved, etc.). In other example embodiments, however, the teeth 112 (e.g., one or more of the teeth 112, etc.) may be curved or arched or hooked (see, e.g., FIGS. 10A-11).

With additional reference to FIG. 2, each of the teeth 112 generally includes an end (or tip) portion 116 positioned furthest away from the central portion 114 of the body 104, and a base portion 118 adjacent the central portion 114 of the body 104 (e.g., where the teeth 112 couple to or extend to/from the central portion 114, etc.). In addition, adjacent ones of the teeth 112 (e.g., pairs of the teeth 112, etc.) are spaced apart from each other and define a channel 120 therebetween. As such, the body 104 includes (or defines) multiple channels 120 between the multiple teeth 112 on both sides of the central portion 114. The teeth 112 are also generally triangular in shape (e.g., as viewed from above the body 104, etc.), such that a spacing between adjacent ones of the teeth 112 at the end portions 116 of the teeth 112 is generally greater than a spacing between adjacent ones of the teeth 112 at the base portions 118 of the teeth 112 (broadly, the teeth 112 taper or define a tapered structure or configuration such that the corresponding channels 120 defined by the pairs of teeth 112 are also tapered (or define a tapered configuration), etc.). In this way, the adjacent ones of the teeth 112 define a generally narrowed pinch point 122 (or wedge) near the base portion 118 of the teeth 112 (e.g., adjacent the central portion 114 of the body 104, etc.) for capturing vegetation between the teeth 112.

More generally, the channels 120 defined between the teeth 112 of the body 104 each define an inlet 124 (adjacent the end portions 116 of the teeth 112) configured to receive vegetation into the channels 120 (and between the corresponding adjacent teeth 112). And, the channels 120 are configured to guide the received vegetation to the corresponding pinch points 122. In connection therewith, each of the channels 120 then narrows in dimension as it extends from the inlet 124 to the pinch point 122 (adjacent the base portions 118 of the teeth 112). Thus, as the vegetation moves along the channel 120, the dimension of the channel 120 eventually constricts to be generally smaller than a corresponding dimension of the vegetation and pinches the vegetation so that the vegetation is captured between the teeth 112 (and cut, pulled, severed, etc. from the ground surface). The pinch point 122, in this example, generally defines an angled vertex configured to capture and retain the vegetation (e.g., having an angle of about fifty degrees or less, an angle of about forty-five degrees or less, an angle of about forty degrees or less, an angle of about thirty-five degrees or less, an angle of about thirty degrees or less, an angle of about twenty-five degrees or less, an angle of about twenty degrees or less, an angle of about fifteen degrees or less, an angle of about ten degrees or less, an angle of about five degrees or less, an angle of between about five degrees and about fifty degrees, etc.). Further, in some examples, the pinch point may continue as a slit or cut, for instance, with no room between opposing sides, but where the slit or cut may then separate (or open) when the body 104 is deformed (e.g., pushed, flattened, etc.) (as generally described herein).

In addition, in the illustrated embodiment, each of the teeth 112 is generally tapered in elevation (e.g., between a bottom surface 126 of the body 104 and a top surface 128 of the body 104, etc.). A thickness of each of the teeth 112 is therefore generally greater toward the base portion 118 than toward the end portion 116. As such, as the device 100 is moved across the ground surface and vegetation enters the channels of the body 104, the teeth 112 are configured to elevate or pull (or raise or lift) the vegetation away from the ground surface as the vegetation approaches the pinch points 122 between the adjacent teeth 112. In this way, the upper or top portions of the vegetation are captured in the pinch points (e.g., tops of weeds where they branch out, unsightly flowers along tops of weeds, etc.). For instance, clover flowers 130 are shown captured in the pinch points of the device 100 in FIG. 2.

In some example embodiments, the body 104 of the device 100 may include teeth 112 on other sides of the body 104, for example, side 132 and/or side 134 as viewed in FIG. 1. As such, all or substantially all of a perimeter of the body 104 may includes teeth 112 in such embodiments. In this way, the device 100 may be moved in any desired direction across the ground surface for removing vegetation.

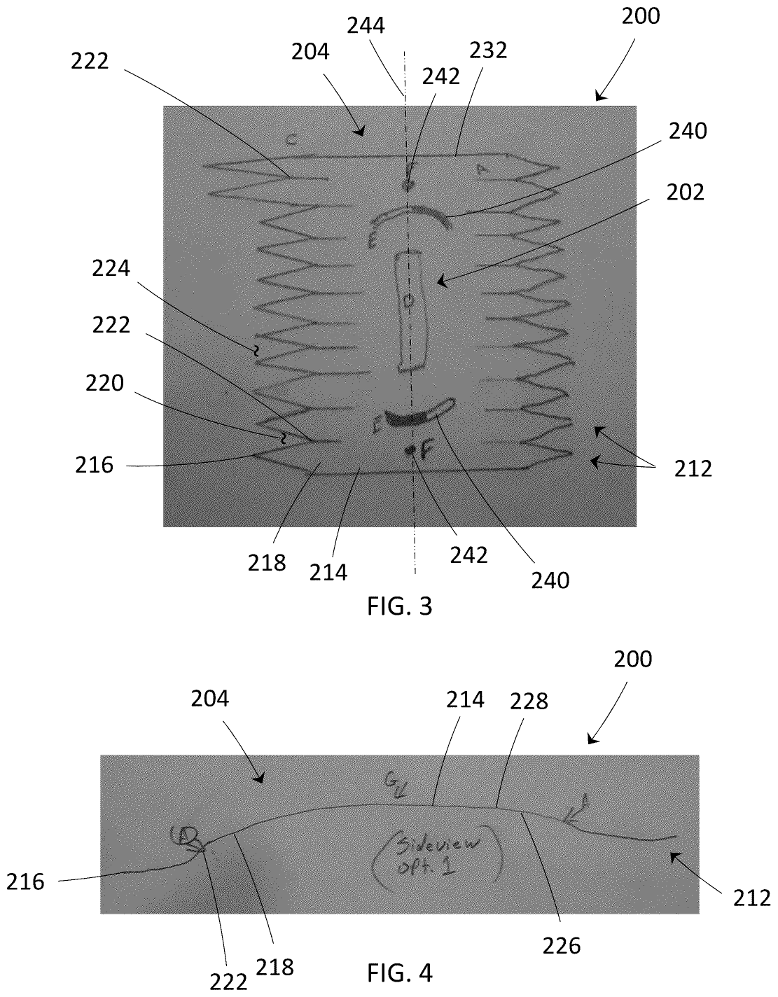

FIGS. 3-5 illustrate another example embodiment of a device 200 for use in removing vegetation from a ground surface. The device 200 is similar to the device 100 described above and illustrated in FIG. 1. As such, the description of the device 100 provided above generally applies to the device 200 of this embodiment.

That said, as shown in FIG. 3, the device 200 of this example embodiment generally includes a handle 202 and a body 204. The handle 202 of this embodiment includes an opening defined in the body 204, whereby a user may position a hand in the opening for grasping and operating the device 200 (e.g., for moving the device 200 across the ground surface to engage and remove vegetation from the ground surface as desired, etc.). That said, it should again be appreciated that the device 200 may include one or more handles having other configurations in other embodiments (e.g., the device 200 may include the handle 102 described above with reference to FIG. 1, the device 200 may include a protruding handle, etc.).

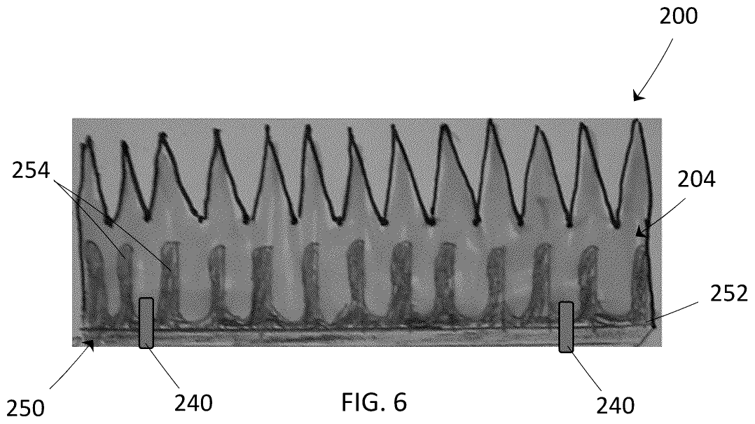

In addition in this embodiment, the illustrated device 200 also includes mounts 240 configured to couple the body 204 to a rake, a hoe, or other tool, whereby a handle 202 of the rake or other tool may be used to operate the device 200. For instance, the mounts 240 may include straps, loops, etc. (e.g., hook and loop fasteners, etc.) configured to fit over a head of a conventional rake, etc., such that the device 200 may be coupled to the head of the rake and an operator may then use a handle of the rake to operate the device 200 (see, for example, FIG. 6). Further, the device 200 includes openings 242 for use in coupling the device 200 to the handle 102 described above with reference to FIG. 1. In particular, the fasteners 108 may be used to couple the mount 106 (and handle 102) to the body 204 via the openings 242, whereby the handle 102 may then be used to operate the device 200.

The device 200 of this embodiment also includes multiple teeth 212 extending from a central or middle portion 214 of the body 204 and configured to engage the ground surface, and the vegetation thereon, in use of the device 200. In the illustrated embodiment, the teeth 212 are provided in rows (or sets) on opposing sides of the body 204 (e.g., a left row and a right row on respective left and right sides of the body 204 illustrated in FIG. 3, etc.). As such, the teeth 212 (e.g., a row or set of teeth 212, etc.) on one side of the body 204 (e.g., on one side of the central portion 214, etc.) are directed in (or face) a first direction, and the teeth 212 (e.g., a row or set of teeth 212, etc.) on the other side of the body 204 (e.g., on the other side of the central portion 214, etc.) are directed in (or face) a second direction generally opposite the first direction.

As in the embodiment described above, each of the teeth 212 in this embodiment generally includes an end (or tip) portion 216 positioned furthest away from the body 204, and a base portion 218 adjacent the body 204 (e.g., where the teeth 212 couple to or extend to/from the central portion 214 of the body 204, etc.). In addition, adjacent ones of the teeth 212 (e.g., pairs of the teeth 212, etc.) are spaced apart from each other and define a channel 220 therebetween. As such, the body 204 includes (or defines) multiple channels 220 between the multiple teeth 212 on both sides of the central portion 214. The teeth 212 are also generally triangular in shape, such that a spacing between adjacent ones of the teeth 212 at the end portions 216 of the teeth 212 is generally greater than a spacing between adjacent ones of the teeth 212 at the base portions 218 of the teeth 212 (broadly, the teeth 212 taper or define a tapered structure or configuration such that the corresponding channels 220 defined by the pairs of teeth 212 are also tapered (or define a tapered configuration), etc.). In this way, the adjacent ones of the teeth 212 define a generally narrowed pinch point 222 near the base portions 218 of the teeth 212 (e.g., adjacent the central portion 214 of the body 204, etc.) for capturing vegetation between the teeth 212.

More generally, the channels 220 defined between the teeth 212 of the body 204 each define an inlet 224 (adjacent the end portions 216 of the teeth 212) configured to receive vegetation into the channels 220 (and between the corresponding adjacent teeth 212). And, the channels 220 are configured to guide the received vegetation to the corresponding pinch points 222. In connection therewith, each of the channels 220 then narrows in dimension as it extends from the inlet 224 to the pinch point 222 (adjacent the base portions 218 of the teeth 212). Thus, as the vegetation moves along the channel 220, the dimension of the channel 220 eventually constricts to be generally smaller than a corresponding dimension of the vegetation and pinches the vegetation so that the vegetation is captured between the teeth 212 (and cut, pulled, severed, etc. from the ground surface). The pinch point 222, in this example, generally defines an angled vertex configured to capture and retain the vegetation.

Further, in the illustrated embodiment, each of the teeth 212 is generally tapered in elevation (e.g., between a bottom surface 226 of the body 204 and a top surface 228 of the body 204, etc.). A thickness of each of the teeth 212 is therefore generally greater toward the base portion 218 than toward the end portion 216. As such, as the device 200 is moved across the ground surface and vegetation enters the channels 220 of the body 204, the teeth 212 are configured to elevate or pull (or raise) the vegetation away from the ground surface as the vegetation approaches the pinch points 222 between the adjacent teeth 212. In this way, the upper or top portions of the vegetation are captured in the pinch points 222 (e.g., tops of weeds where they branch out, unsightly flowers along tops of weeds, etc.).

In the illustrated embodiment, two of the teeth 212 adjacent side 232 of the body 204 (e.g., at an upper left corner of the body 204 as illustrated in FIG. 3, etc.) are generally longer than other ones of the teeth 212. In addition, the pinch point 222 defined between these longer teeth 212 is located further away from the body 204 than the other pinch points 222 (e.g., further away from longitudinal axis 244 of the body 204, etc.). This may allow for more accurate removal of vegetation, for example, in narrow areas or hard-to-reach areas of a yard (e.g., adjacent trees, adjacent fences or fence corners, etc.). While in the illustrated embodiment only two of the teeth 212 are shown longer than other teeth 212, it should be appreciated that more than two of the teeth 212 may be provided with such longer lengths in other embodiments (e.g., pairs of teeth 212 at one or more additional corners of the body 204 may be provided with such longer lengths, etc.).

With additional reference to FIG. 4, in this example embodiment, the central portion 214 of the body 204 includes (or defines) a generally arched, or curved configuration. In particular in this embodiment, the central portion 214 of the body 204 curves generally upward (e.g., defines a generally convex shape when viewed from above, etc.). In connection therewith, the teeth 212 are configured to slide across the ground surface during use of the device 200 (with end portions 216 of the teeth 212 all generally arranged in a common plane, etc.). However, in this example, the pinch points 222 defined by the channels 220 between the teeth 212 are generally positioned higher (in elevation) than the end portions 216 of the teeth 212. As such, as the device 200 is moved across the ground surface and vegetation enters the channels 220 of the body 204, the teeth 212 are configured to elevate or pull (or raise) the vegetation away from the ground surface as the vegetation approaches the pinch points 222 between the adjacent teeth 212. In this way, the upper or top portions of the vegetation are captured in the pinch points 222 (e.g., tops of weeds where they branch out, unsightly flowers along tops of weeds, etc.). The curved central portion 214 of the body 204 may then be generally flattened (e.g., the shape of the body 204 may be changed, etc.) to generally expand or open the pinch points 222. In doing so, any vegetation collected within the pinch points 222 may be released from the expanded/opened pinch points 222.

Alternatively in this embodiment, as shown in FIG. 5, the central portion 214′ of the body 204 may curve generally downward (e.g., the central portion 214′ may define a generally concave shape when viewed from above, etc.). In connection therewith, the teeth 212 are again configured to slide across the ground surface during use of the device 200 (with end portions 216 of the teeth 212 all generally arranged in a common plane, etc.). However, in this example, the central portion 214′ of the body 204 may also engage and/or slide cross the ground surface. In addition, the pinch points 222 defined by the channels 220 between the teeth 212 are generally positioned higher (in elevation) than the end portions 216 of the teeth 212. As such, as the device 200 is moved across the ground surface and vegetation enters the channels 220 of the body 204, the teeth 212 are configured to elevate or pull (or raise) the vegetation away from the ground surface as the vegetation approaches the pinch points 222 between the adjacent teeth 212. In this way, the upper or top portions of the vegetation are captured in the pinch points 222 (e.g., tops of weeds where they branch out, unsightly flowers along tops of weeds, etc.). The curved central portion 214′ of the body 204 may then be generally flattened (e.g., the shape of the body 204 may be changed, etc.) to generally expand or open the pinch points 222. In doing so, any vegetation collected within the pinch points may be released from the pinch points 222.

FIG. 6 illustrates an example embodiment of the device 200, in which the device 200 is removably coupled to a conventional rake 250, for example, via the mounts 240. For instance, in this example, the mounts 240 include straps (e.g., one or more straps, etc.) configured to fit over a head 252 of the rake 250 (e.g., via hook and loop fasteners, etc.) (e.g., between tines 254 of the rake, etc.), whereby the body 204 of the device 200 is removably (or releasably) coupled to the head 252 of the rake 250. An operator may then use a handle (not shown) of the rake 250 to operate the device 200.

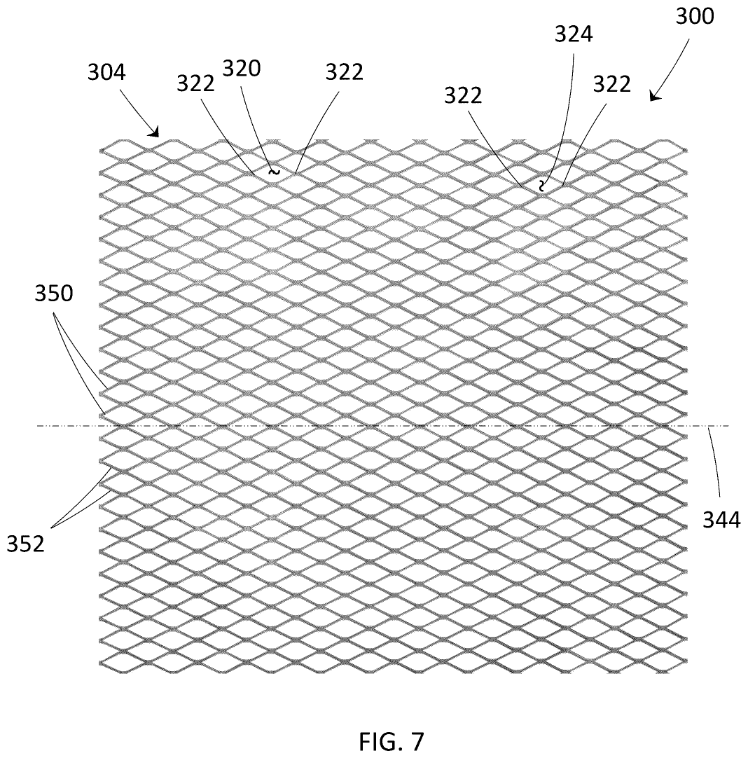

FIGS. 7-9 illustrate another example embodiment of a device 300 for use in removing vegetation from a ground surface.

In this example embodiment, the device 300 includes a body 304 having multiple intersecting cross members 350, 352. In particular, the body 304 includes a first group of generally parallel cross members 350 extending across the body 304 in a first direction, and a second group of generally parallel cross members 352 extending across the body 304 in a second direction. In connection therewith, the cross members 350 intersect various ones of the cross members 352 to form multiple channels 320 each extending in a longitudinal direction 344 of the body 304 (e.g., diamond-shaped channels 320 in the illustrated embodiment having longitudinal axes extending generally parallel to the longitudinal direction 344 of the body 304, etc.).

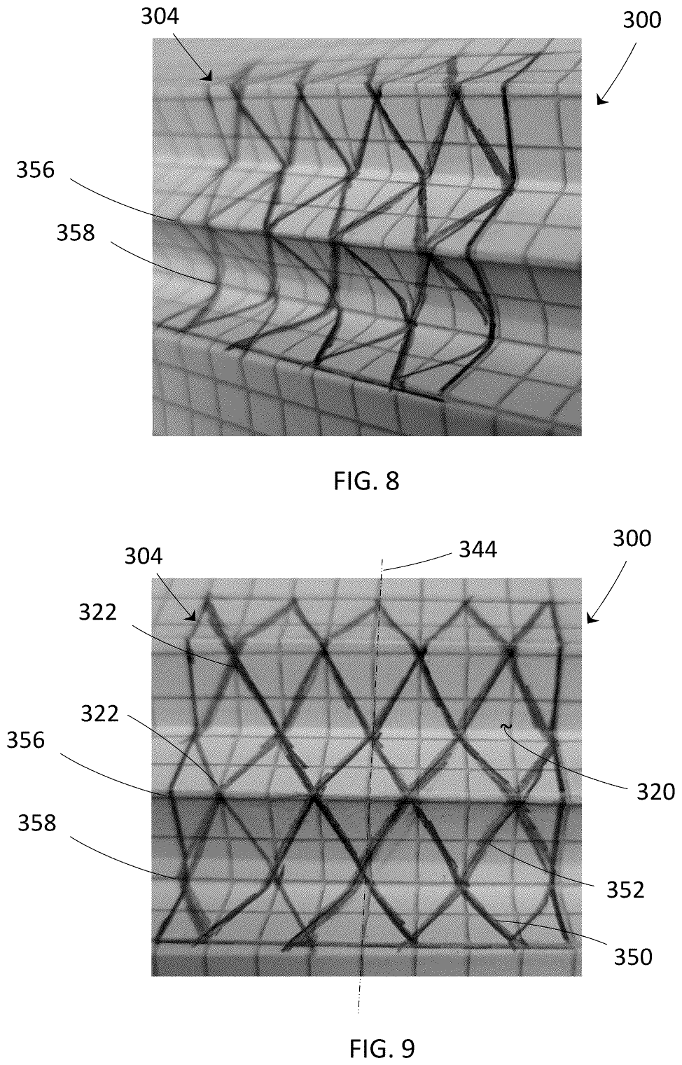

In addition, as best shown in FIGS. 8-9, the body 304 includes multiple bends (or folds) extending generally transverse to the longitudinal direction 344 of the body 304. As such, the body 304 defines multiple narrowed pinch points 322 at each of the longitudinal vertex points of the channels 320 (e.g., where a cross member 350 of the first group intersects a cross member 352 of the second group, etc.). What's more, the bends of the body 304 locate some of the pinch points 322 at upper peak locations 356 of the body 304 (e.g., high points of the body 304 relative to the ground surface, etc.) and other ones of the pinch points 322 at lower trough portions 358 of the body 304 (e.g., low points of the body 304 configured to engage the ground surface, etc.). In connection therewith, transverse extending mid-portions of the channels 320 then define inlets 324 for receiving vegetation into the channels 320 and for directing the vegetation to the pinch points 322. As such, in this embodiment, each of the channels 320 defines two pinch points 322 at generally opposite longitudinal end portions of the channel 320. In addition, each of the channels 320 in this embodiment also narrows in dimension as it extends from the inlet 324 to the pinch point 322. Thus, as the vegetation moves along the channel 320, the dimension of the channel eventually constricts to be generally smaller than a corresponding dimension of the vegetation and pinches the vegetation so that the vegetation is captured at or by the pinch points 322 (and cut, pulled, severed, etc. from the ground surface).

Further, as described, different ones of the pinch points 322 are located at different heights (or elevations) relative to the ground surface. As such, as the device 300 is moved across the ground surface, vegetation at different heights along the ground surface may be captured by the channels 320 of the body 304. In this way, the upper or top portions of the vegetation (generally regardless of height, etc.) may be captured in the pinch points 322 (e.g., tops of weeds where they branch out, unsightly flowers along tops of weeds, etc.).

That said, the device 300 of this embodiment may be used by moving the device 300 across the ground surface in a direction generally parallel to the longitudinal direction 344 of the body 304 (e.g., either forward or backward, etc.). What's more, the device 300 may be moved across the ground surface by any suitable means. For instance, the device 300 may be manually moved across the ground surface (e.g., pulled by a user via a rope, moved by a user via a handle as described herein, etc.) or pulled via an automated device 300 (e.g., a lawn mower, a tractor, and ATV, etc.). Further, in connection with moving the device 300 across the ground surface, tension may be applied to the device 300 (e.g., a downward force via a handle, a weight, etc.). In doing so, the device 300 may resiliently deform downward toward the ground surface (upon application of the tension, etc.) and then return to its un-deformed shape upon removal of the tension (e.g., the device may have a spring-like characteristic, etc.). As such, in use, application of the tension to the device 300, and the resiliently deformable nature thereof, may help maintain the device 300 in contact with the ground surface and/or help conform a lower surface of the device 300 to a contour of the ground surface, etc., thereby improving removable of vegetation.

FIGS. 10A-11 illustrate another example embodiment of a device 400 for use in removing vegetation from a ground surface. The device 400 is similar to the device 100 described above and illustrated in FIG. 1. As such, the description of the device 100 provided above generally applies to the device 400 of this embodiment.

As shown in FIG. 10A, the device 400 includes a body 404 having multiple teeth 412 extending from the body 404. Adjacent ones of the teeth 412 (e.g., pairs of the teeth 112, etc.) are spaced apart from each other and define a channel therebetween. As such, the body 404 includes (or defines) multiple channels between the multiple teeth 412. The teeth 412 are also generally tapered in shape, such that a spacing between adjacent ones of the teeth 412 at end portions of the teeth is generally greater than a spacing between adjacent ones of the teeth 412 at base portions of the teeth 412 (as generally described above for the device 100). In this way, the adjacent ones of the teeth 412 define a generally narrowed pinch point 422 (or wedge) (see, also, FIG. 10B) near the base portion of the teeth 412 (e.g., at the body 404, etc.) for capturing vegetation between the teeth 112.

In this embodiment, the teeth 412 are generally curved (or arched at a radius or hooked). As such, the pinch points 422 (or wedges) associated with the teeth 412 in this embodiment are also generally curved (or arched at a radius or hooked). This configuration of the pinch points 422 (or wedges) may help remove weed tops, flowers, etc., and may help a user articulate the device as needed to engage the weeds at desired angles.

In various embodiments, the device 400 may include two of the bodies 404 arranged generally back-to-back. As such, the teeth 412 on the body 404 on one side of the device are directed in (or face) a first direction, and the teeth 112 on the body on the other side of the device 400 are directed in (or face) a second direction generally opposite the first direction. In such embodiments, the device may be operated (or swung) back-and-forth to remove vegetation, weeds, flowers, etc. using the two teeth 112 arranged on generally opposite sides of the device 400.

In some example embodiments, the device 400 may include curved pinch points 422′ (or wedges) separately coupled to existing tools (e.g., inserted between the teeth 412, coupled over the body of the tools, etc.). In this way, existing tools (e.g., rakes, leaf scoops, etc.) may be retrofitted with such pinch points 422 (or wedges) for use as described herein (see, also, FIG. 6, etc.).

In view of the above, the example devices of the present disclosure may be used to quickly remove flowers from undesired weeds from ground surfaces (e.g., from laws, yards, etc.). In connection therewith, the devices herein provide an environmentally friendly option for removing the flowers, for example, in lieu of chemical treatments, etc. and/or provide an option for quickly removing the flowers where the color of the flowers may be undesired (e.g., white clover flowers in an otherwise green law, etc.).

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A device for removing vegetation from ground surfaces, the device comprising a body defining multiple channels, wherein each channel of the multiple channels has an inlet for receiving vegetation into the channel and a pinch point for capturing the vegetation in the channel, and wherein a width dimension of each channel of the multiple channels at the inlet is greater than a width dimension of said channel at the pinch point.

2. The device of claim 1, wherein the pinch point of each channel of the multiple channels defines an angled vertex.

3. The device of claim 1, wherein the pinch point of each channel of the multiple channels is elevated relative to the inlet of said channel.

4. The device of claim 1, further comprising multiple teeth extending from the body, wherein each channel of the multiple channels is defined by a pair of adjacent teeth of the multiple teeth.

5. The device of claim 4, wherein the multiple teeth include a first row of teeth and a second row of teeth, and wherein the first row of teeth are disposed along a first side of the body and the second row of teeth are disposed along a second side of the body opposite the first side of the body.

6. The device of claim 5, wherein the body includes a central portion disposed between the first row of teeth and the second row of teeth, and wherein the central portion defines an arched configuration.

7. The device of claim 6, wherein at least two adjacent ones of the multiple teeth are longer than all other ones of the multiple teeth.

8. The device of claim 7, wherein the central portion defines one of a concave shape and a convex shape.

9. The device of claim 6, wherein the multiple teeth each extend away from the central portion.

10. The device of claim 6, wherein tip portions of the multiple teeth are all disposed within a common plane.

11. The device of claim 1, further comprising a handle coupled to the body.

12. The device of claim 11, wherein the handle includes an elongate shaft extending away from the body.

13. The device of claim 11, wherein the handle is oriented at an angle of about fifty degrees or less relative to the body.

14. The device of claim 1, wherein the body includes multiple intersecting cross members.

15. The device of claim 14, wherein the body includes multiple folds defining multiple trough locations and multiple peak locations across the body, and wherein at least one channel of the multiple channels defines a pinch point at one of the multiple trough locations and wherein at least another channel of the multiple channels defines a pinch point at one of the multiple peak locations.

16. The device of claim 14, wherein each channel of the multiple channels defines multiple pinch points.

17. A method for removing vegetation from ground surfaces, using a device comprising a body defining multiple channels, wherein each channel of the multiple channels has an inlet for receiving vegetation into the channel and a pinch point for capturing the vegetation in the channel, and wherein a width dimension of each channel of the multiple channels at the inlet is greater than a width dimension of said channel at the pinch point, the method comprising:
moving the device across the ground surface;
directing the vegetation into one or more of the multiple channels, via the corresponding inlet(s) of the one or more multiple channels; and
at each of the one or more of the multiple channels, capturing at least some of the vegetation at the corresponding pinch point.

18. The method of claim 17, further comprising coupling the device to a head of a rake; and
wherein moving the device across the ground surface includes moving the device across the ground surface using a handle of the rake.

19. The method of claim 18, wherein coupling the device to the head of the rake includes removable coupling the device to the head of the rake using one or more straps.
